(19) United States
(12) Patent Application Publication
(10) Pub. No.: US 2021/0333899 A1
(43) Pub. Date: Oct. 28, 2021

(54) TOUCH PANEL, MANUFACTURING METHOD THEREOF, AND ELECTRONIC DEVICE

(71) Applicant: WUHAN CHINA STAR OPTOELECTRONICS SEMICONDUCTOR DISPLAY TECHNOLOGY CO., LTD., Wuhan (CN)

(72) Inventor: Yuanhang LI, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/469,659

(22) PCT Filed: Feb. 21, 2019
(86) PCT No.: PCT/CN2019/075664

§ 371 Date: Jun. 14, 2019

(30) Foreign Application Priority Data
Dec. 18, 2018 (CN) 201811548094.0

(51) Int. Cl. G06F 3/041

(52) U.S. Cl. CPC G06F 3/041; G06F 2203/04103

(57) ABSTRACT

A touch panel, a manufacturing method thereof, and an electronic device are provided. The touch panel includes a touch area and a bonding area. The touch area is provided with a substrate, a first electrode layer including first electrodes and second electrodes, and at least one electrode lead group including electrode leads, wherein one of the electrode leads corresponds to one of the first electrodes or one of the second electrodes. Each of the electrode leads is led out from an edge of the first electrode or an edge of the second electrode.

### FIELD OF INVENTION

The present disclosure relates to a display field, and in particular to a touch panel, a manufacturing method thereof, and an electronic device.

### BACKGROUND OF INVENTION

Currently, most commonly used touch technologies include external touch technology and in-cell touch technology, where the external touch technology is to embed touch sensors on a display panel. That is, the touch sensors are provided on a liquid crystal panel of the display panel. Compared to the in-cell touch technology, there is a decreased in difficulty in using the external touch technology.

Existing touch sensors include touch electrodes disposed in touch areas and touch traces disposed at a periphery of the touch electrodes. The touch traces must be disposed at a black frame on both sides of the display panel to shield the touch traces. However, a width of the black frame of the display panel is increased, and does not satisfy a user need for a narrow border.

### SUMMARY OF INVENTION

An object of the present disclosure is to provide a touch panel, a manufacturing method thereof, and an electronic device to solve the technical problem of large spacing of the black frame on both sides of the existing display panel.

To achieve the above objects, the present disclosure provides a touch panel, the touch panel includes a touch area and a bonding area located on a side of the touch area, wherein the touch area is provided with a substrate, a first electrode layer, and at least one electrode lead group, wherein the first electrode layer is located on a side of the substrate and includes first electrodes and second electrodes arranged in a first direction. The electrode lead group includes electrode leads, wherein one of the electrode leads corresponds to one of the first electrodes or one of the second electrodes. Each of the electrode leads is led out from an edge of the first electrode or an edge of the second electrode and extends to the bonding area through the touch area.

In an embodiment of the present disclosure, the touch area includes a first area and a second area; the first area is provided with the first electrodes; the second area is provided with the second electrodes.

In an embodiment of the present disclosure, the touch panel comprises a first electrode lead group and a second electrode lead group; the first electrode lead group include first electrode leads electrically connected to the first electrodes in the first area, and the first electrode lead is led out from a corresponding edge of the first electrode and extends to the bonding area through the touch area; the second electrode lead group include second electrode leads electrically connected to the second electrodes in the second area, and the second electrode lead is led out from a corresponding edge of the second electrode and extends to the bonding area through the touch area.

In an embodiment of the present disclosure, the first electrode leads and the second electrode leads include a first connecting section and a second connecting section; one end of the first connecting section is connected to the corresponding first electrode through a via hole, and the other end of the first connecting section is connected to the second connecting section; one end of the second connecting section is perpendicularly connected to the first connecting section, and the other end of the second connecting section extends to the bonding area; the first connecting section is parallel to the first direction, and the second connecting section is perpendicular to the first direction.

In an embodiment of the present disclosure, the bonding area includes a first bonding region and a second bonding region; the first electrode leads extend to the first bonding region through the touch area; the second electrode leads extend to the second bonding region through the touch area; the first bonding region, the second bonding region, and the first electrode layer are located on the same side of the substrate.

In an embodiment of the present disclosure, the electrode lead group is located between the substrate and the first electrode layer, or the electrode lead group is located above the first electrode layer away from the substrate.

In an embodiment of the present disclosure, a first insulating layer is disposed between the electrode lead group and the first electrode layer.

In an embodiment of the present disclosure, the touch area is further provided with a second electrode layer and a third electrode lead group, wherein the second electrode layer is located on a side of the substrate away from the first electrode layer and includes third electrodes arranged in a second direction, and the third electrode lead group includes third electrode leads electrically connected to the third electrodes, wherein one of the third electrode leads is led out from a corresponding side of the third electrode adjacent to the bonding area and extends to the bonding area.

In an embodiment of the present disclosure, the bonding area further includes a third bonding region; the third bonding region and the second electrode layer are located on the same side of the substrate; the third electrode leads are connected to the third bonding region.

In an embodiment of the present disclosure, a first angle is formed between the third electrode lead and the third bonding region; the first angle between the third electrode lead and the third bonding region near a boundary of the touch panel is the smallest; the first angle between the third electrode lead and the third bonding region located at an intermediate portion of the touch panel is the largest.

In an embodiment of the present disclosure, the third electrodes are disposed perpendicular to the first electrodes, and the third electrodes are disposed perpendicular to the second electrodes.

In an embodiment of the present disclosure, the third electrode lead group and the second electrode layer are disposed in the same layer.

The present disclosure further provides an electronic device, the electronic device includes a touch panel and a flexible circuit board connected to the touch panel, wherein the touch panel includes a touch area and a bonding area located on a side of the touch area, and the touch area is provided with a substrate, a first electrode layer, and at least one electrode lead group, wherein the first electrode layer is located on a side of the substrate and including first electrodes and second electrodes arranged in a first direction. The electrode lead group includes electrode leads, wherein one of the electrode leads corresponds to one of the first electrodes or one of the second electrodes. Each of the electrode leads is led out from an edge of the first electrode or an edge of the second electrode and extends to the bonding area through the touch area.

In an embodiment of the present disclosure, the touch area includes a first area and a second area; the first area is provided with the first electrodes; the second area is provided with the second electrodes; the touch panel comprises a first electrode lead group and a second electrode lead group; the first electrode lead group include first electrode leads electrically connected to the first electrodes in the first area, and the first electrode lead is led out from a corresponding edge of the first electrode and extends to the bonding area through the touch area; the second electrode lead group include second electrode leads electrically connected to the second electrodes in the second area, and the second electrode lead is led out from a corresponding edge of the second electrode and extends to the bonding area through the touch area.

In an embodiment of the present disclosure, the first electrode leads and the second electrode leads include a first connecting section and a second connecting section; one end of the first connecting section is connected to the corresponding first electrode through a via hole, and the other end of the first connecting section is connected to the second connecting section; one end of the second connecting section is perpendicularly connected to the first connecting section, and the other end of the second connecting section extends to the bonding area; the first connecting section is parallel to the first direction, and the second connecting section is perpendicular to the first direction.

In an embodiment of the present disclosure, the bonding area includes a first bonding region and a second bonding region; the first electrode leads extend to the first bonding region through the touch area; the second electrode leads extend to the second bonding region through the touch area; the first bonding region, the second bonding region, and the first electrode layer are located on the same side of the substrate.

In an embodiment of the present disclosure, the touch area is further provided with a second electrode layer and a third electrode lead group, wherein the second electrode layer is located on a side of the substrate away from the first electrode layer and including third electrodes arranged in a second direction. The third electrode lead group includes third electrode leads electrically connected to the third electrodes, wherein one of the third electrode leads is led out from a corresponding side of the third electrode adjacent to the bonding area and extends to the bonding area. The bonding area further includes a third bonding region. The third bonding region and the second electrode layer are located on the same side of the substrate. The third electrode leads are connected to the third bonding region.

In an embodiment of the present disclosure, the flexible circuit board includes a first terminal area corresponding to the first bonding region, a second terminal area corresponding to the second bonding region, and a third terminal area corresponding to the third bonding region. The first terminal area and the second terminal area are located on one side of the substrate in the touch panel, and the third terminal area is located on the other side of the substrate in the touch panel.

The present disclosure further provides a manufacturing method of a touch panel, and the manufacturing method includes: S10, providing a substrate and forming a first metal layer on the substrate, wherein the first metal layer is formed into a first electrode layer through a first mask process; S20, forming a first insulating layer on the first electrode layer, wherein a via hole corresponding to the first electrode layer on the first insulating layer is formed through a second mask process; S30, forming a second metal layer on the first insulating layer, wherein a first electrode lead group and a second electrode lead group are formed on the second metal layer through a third mask process, and the first electrode lead group and the second electrode lead group are connected to the first electrode layer through the via hole; S40, forming a third metal layer on a side of the substrate away from the first electrode layer, wherein the third metal layer forms a second electrode layer and third electrode lead group electrically connected to the second electrode layer through fourth mask process.

In an embodiment of the present disclosure, before the step S40, the manufacturing method further comprises forming a second insulating layer on the second metal layer; after the step S40, the manufacturing method further comprises forming a third insulating layer on the third metal layer.

The beneficial effect is that the present disclosure disposes the touch trace located in the touch area. Thus, a width of the black frame of the touch panel is reduced, and a narrow bezel design is realized, which improves the user experience.

### DESCRIPTION OF DRAWINGS

In order to more clearly illustrate the embodiments or prior art technical solutions embodiment of the present disclosure, will implement the following figures for the cases described in prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a cross-sectional view of a touch panel according to the present disclosure.

FIG. 2 is a top view of a touch panel according to the present disclosure.

FIG. 3 is a bottom view of a touch panel according to the present disclosure.

FIG. 4 is a flow chart of a manufacturing method of a touch panel according to the present disclosure.

FIGS. 5A-5D are schematic views of the manufacturing method of the touch panel according to the present disclosure.

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

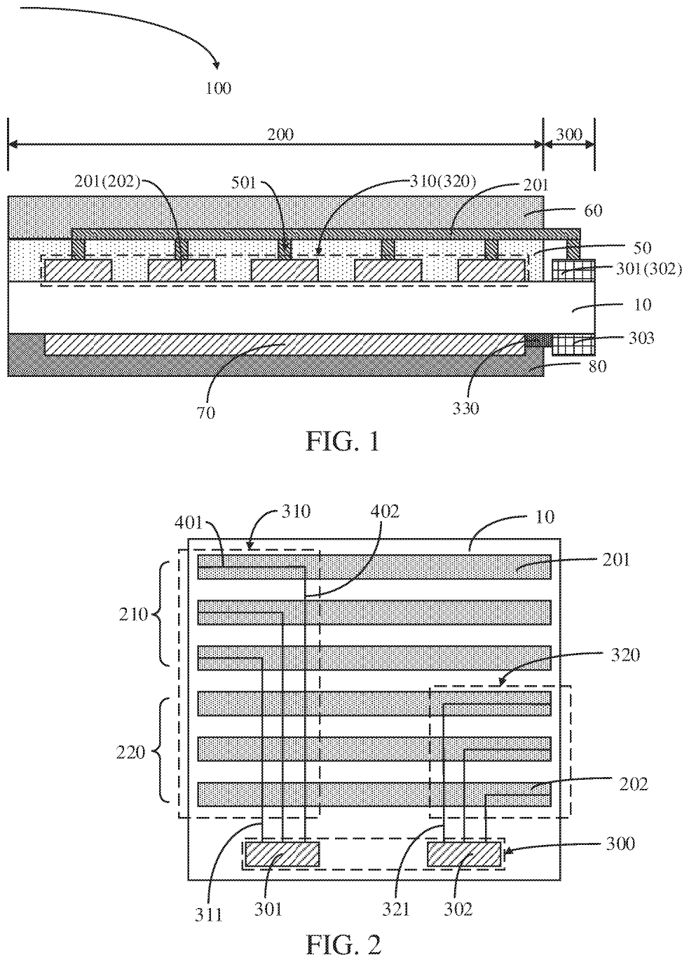

Referring to FIG. 1, a cross-sectional view of a touch panel according to the present disclosure is illustrated.

Referring to FIG. 2, a top view of a touch panel according to the present disclosure is illustrated.

The touch panel 100 includes a touch area 200 and a bonding area 300 located on a side of the touch area 200. The touch area 200 includes a first area 210 and a second area 220, and the touch area 200 is provided with a substrate 10 and a first electrode layer 20. Material of the substrate 10 can be one of a glass substrate, a quartz substrate, and a resin substrate. The first electrode layer 20 is located on a side of the substrate 10, and includes first electrodes 201 and second electrodes 202 arranged in a first direction, wherein the first electrodes 201 are parallel to the second electrodes 202.

In an embodiment, the first electrodes 201 are located on the first area 210 of the touch area 200, and the first area 210 is provided with the first electrodes 201.

In an embodiment, the second electrodes 202 are located on the second area 220 of the touch area 200, and the second area 220 is provided with the second electrodes 202.

In an embodiment, an area of the first area 210 is equal to an area of the second area 220, and a number of the first electrodes 201 is equal to a number of the second electrodes 202.

In an embodiment, the shape of the first electrodes 201 and the second electrodes 202 are the same.

In an embodiment, the shape of the first electrodes 201 and the second electrodes 202 are one of a long strip, a square, or a diamond.

When the first electrodes 201 are a plurality of bulk electrodes, the bulk electrodes are electrically connected by metal wires to form the first electrodes 201. When the second electrodes 202 are a plurality of bulk electrodes, the bulk electrodes are electrically connected by metal wires to form the second electrodes 202.

The touch area 200 is provided with at least one electrode lead group, wherein the electrode lead group includes electrode leads, and one of the electrode leads corresponds to one of the first electrodes 201 or one of the second electrodes 202. Each of the electrode leads is led out from an edge of the first electrode 201 or an edge of the second electrode 202 and extends to the bonding area 300 through the touch area 200.

The touch panel 100 includes a first electrode lead group 310 and a second electrode lead group 320. The first electrode lead group 310 includes first electrode leads 311 electrically connected to the first electrodes 201 in the first area 210, and the first electrode lead 311 is led out from a corresponding edge of the first electrode 201 and extends to the bonding area 300 through the touch area 200. The second electrode lead group 320 includes second electrode leads 321 electrically connected to the second electrodes 202 in the second area 220, and the second electrode lead 321 is led out from a corresponding edge of the second electrode 202 and extends to the bonding area 300 through the touch area 200.

The first electrode leads 311 and the second electrode leads 321 include a first connecting section 401 and a second connecting section 402. One end of the first connecting section 401 is connected to the corresponding first electrode 201 through a via hole 501, and the other end of the first connecting section 401 is connected to the second connecting section 402.

In an embodiment, the via hole 501 is formed on a first insulating layer 50 of the first electrode layer 20, and the via hole 501 is located at a position where the first electrodes 201 or the second electrodes 202 are close to a frame of the touch panel 100.

One end of the second connecting section 402 is perpendicularly connected to the first connecting section 401, and the other end of the second connecting section 402 extends to the bonding area 300.

In an embodiment, the first connecting section 401 is parallel to the first direction, and the second connecting section 402 is perpendicular to the first direction. In an embodiment, the first direction is a vertical direction.

In an embodiment, the first connecting section 401 is in a horizontal direction and is located directly above or below the first electrodes 201 or the second electrodes 202. In an embodiment, the second connecting section 402 is in a vertical direction and is perpendicular to the first electrodes 201 or the second electrodes 202.

The bonding area 300 includes a first bonding region 301 and a second bonding region 302. The first electrode leads 311 extend to the first bonding region 301 through the touch area 200. The second connecting section 402 of the first electrode leads 311 extends to the first bonding region 301 through the touch region 200.

The second electrode leads 321 extend to the second bonding region 302 through the touch area 200. The second connecting section 402 of the second electrode leads 321 extends to the second binding region 302 through the touch region 200.

In an embodiment, the first bonding region 301 and the second bonding region 302 are symmetrically disposed with the center line of the touch panel 100 as an axis.

In an embodiment, the first binding region 301, the second bonding region 302, and the first electrode layer 20 are located on the same side of the substrate 10.

In an embodiment, the first electrode lead group 310 or the second electrode lead group 320 is located between the substrate 10 and the first electrode layer 20.

In an embodiment, the first electrode lead group 310 or the second electrode lead group 320 is located above the first electrode layer 20 away from the substrate 10.

In an embodiment, the first electrode lead group 310 is located between the substrate 10 and the first electrode layer 20, and the second electrode lead group 320 is located above the first electrode layer 20 away from the substrate 10.

In an embodiment, the second electrode lead group 320 is located between the substrate 10 and the first electrode layer 20, and the first electrode lead group 310 is located above the first electrode layer 20 away from the substrate 10.

In an embodiment, the first insulating layer 50 is disposed between the first electrode lead group 310 or the second electrode lead group 320 and the first electrode layer 20.

In an embodiment, a second insulating layer 60 is further disposed on the first electrode lead group 310 and the second electrode lead group 320.

In an embodiment, material of the first insulating layer 50 and the second insulating layer 60 are silicon nitride, silicon oxide or silicon oxynitride.

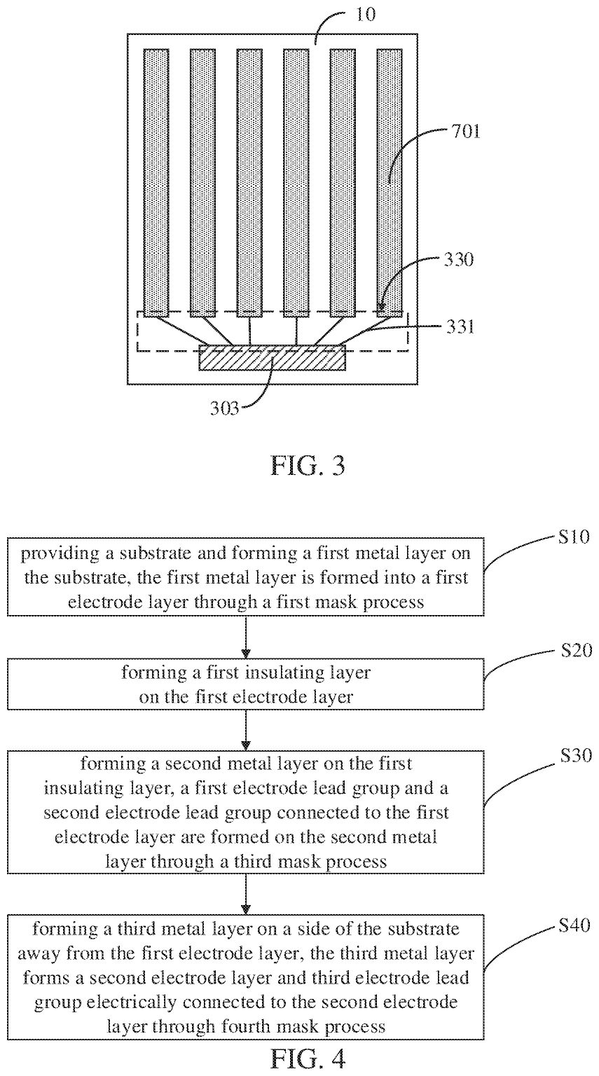

Referring to FIG. 3, a bottom view of a touch panel according to the present disclosure is illustrated.

The touch area 200 is further provided with a second electrode layer 70 and a third electrode lead group 330, wherein the second electrode layer 70 is located on a side of the substrate 10 away from the first electrode layer 20 and includes third electrodes 701 arranged in a second direction. The third electrodes 701 are arranged in parallel with each other.

In an embodiment, the shape of the third electrode 701 is one of a long strip, a square, or a diamond. When the third electrodes 701 are a plurality of bulk electrodes, the bulk electrodes are electrically connected by metal wires to form the third electrodes 701.

The third electrode lead group 330 includes third electrode leads 331 electrically connected to the third electrodes 701, wherein one of the third electrode leads 331 is led out from a corresponding side of the third electrode 701 adjacent to the bonding area 300 and extends to the bonding area 300.

In an embodiment, the second direction is a horizontal direction. Each of the third electrodes 701 is perpendicular to the second direction.

In an embodiment, the third electrodes 701 are disposed perpendicular to the first electrodes 201, and the third electrodes 701 is disposed perpendicular to the second electrodes 202.

In an embodiment, the third electrode lead group 330 and the second electrode layer 70 are disposed in the same layer.

The bonding area 300 further includes a third bonding region 303. The third bonding region 303 and the second electrode layer 70 are located on the same side of the substrate 10 and located in the middle of the touch panel 100. The third electrode leads 331 are connected to the third bonding region 303.

A first angle is formed between the third electrode lead 331 and the third bonding region 303. The first angle between the third electrode lead 331 and the third bonding region 303 near a boundary of the touch panel 100 is the smallest. The first angle between the third electrode lead 331 and the third bonding region 303 located at an intermediate portion of the touch panel 100 is the largest. This connection mode reduces the spacing of the third electrode lead group 330 to be disposed at the lower frame, which is advantageous for the narrow bezel design of the display device.

In an embodiment, the first electrodes 201, the second electrodes 202, and the third electrodes 701 are made of a transparent metal.

In an embodiment, material of the first electrodes 201, the second electrodes 202, and the third electrodes 701 are indium tin oxide (ITO).

In an embodiment, the first electrodes 201, the second electrodes 202, and the third electrodes 701 can exist in the form of a metal mesh, and the metal mesh is formed by arranging horizontally and vertically staggered metal lines around each pixel unit.

In an embodiment, the first electrodes 201 and the second electrode 202 are driving electrodes, and the third electrodes 701 are sensing electrodes.

In an embodiment, the third electrodes 701 are driving electrodes, and the first electrodes 201 and the second electrodes 202 are sensing electrodes.

In an embodiment, the first electrode layer 20 and the second electrode layer 70 are located on the same side of the substrate 10.

The touch panel 100 further includes a third insulating layer 80 located on the second electrode layer 70. Material of the third insulating layer 80 is the same as the material of the first insulating layer 50 and the second insulating layer 60.

The present disclosure disposes the touch trace located on the touch panel 100 in the touch area 200 without occupying the peripheral non-display area of the display device. Thus, a width of the black frame of the touch panel 100 is reduced, and a narrow bezel design is realized, which improves the user experience.

The present disclosure also provides an electronic device, the electronic device includes the touch panel 100 and a flexible circuit board connected to the touch panel 100.

In the electronic device of the present disclosure, the flexible circuit board includes a first terminal area, a second terminal area, and a third terminal area.

In an embodiment, the first terminal area corresponds to the first bonding region 301. The second terminal area corresponds to the second bonding region 302. The third terminal area corresponds to the third bonding region 303.

In an embodiment, the first terminal area and the second terminal area are located on one side of the substrate 10 in the touch panel 100, and the third terminal area is located on the other side of the substrate 10 in the touch panel 100.

The electronic device includes, but is not limited to, a mobile phone, a tablet computer, a computer display, a game machine, a television, a display screen, a wearable device, and other living appliances or household appliances with a display function.

Referring to FIG. 4, a flow chart of a manufacturing method of a touch panel according to the present disclosure is illustrated.

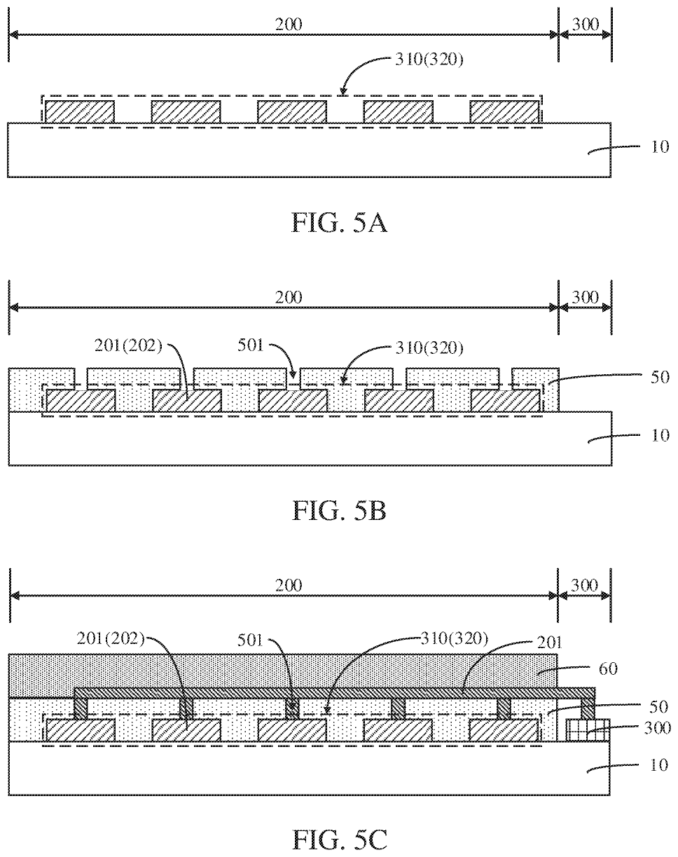

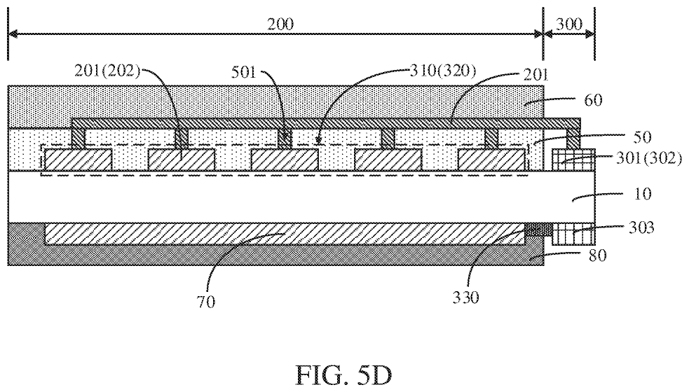

Referring to FIGS. 5A-5D, schematic views of the manufacturing method of the touch panel according to the present disclosure are illustrated.

The manufacturing method includes step S10, providing a substrate and forming a first metal layer on the substrate, wherein the first metal layer is formed into a first electrode layer through a first mask process.

Referring to FIG. 5A, step S10 specifically includes: step S101, providing a substrate; step S102, forming a first metal layer on the substrate; and step 3103, the first metal layer is formed into a first electrode layer through a first mask process.

Referring to FIG. 2, the first electrode layer 20 is located at the touch area 200 of the touch panel 100, and the touch area 200 includes a first area 210 and a second area 220. The first electrode layer 20 includes first electrodes 201 and second electrodes 202 arranged in a first direction, wherein the first electrodes 201 are parallel to the second electrodes 202.

In an embodiment, the first electrodes 201 are located on the first area 210 of the touch area 200, and the first area 210 is provided with the first electrodes 201.

In an embodiment, the second electrodes 202 are located on the second area 220 of the touch area 200, and the second area 220 is provided with the second electrodes 202.

In an embodiment, the area of the first area 210 is equal to the area of the second area 220, and the number of the first electrodes 201 is equal to the number of the second electrodes 202.

In an embodiment, the shape of the first electrodes 201 and the second electrodes 202 are the same.

In an embodiment, the shape of the first electrodes 201 and the second electrodes 202 are one of a long strip, a square, or a diamond.

When the first electrodes 201 are a plurality of bulk electrodes, the bulk electrodes are electrically connected by metal wires to form the first electrodes 201. When the second electrodes 202 are a plurality of bulk electrodes, the bulk electrodes are electrically connected by metal wires to form the second electrodes 202.

In an embodiment, the first metal layer can be made of a transparent metal.

In an embodiment, the first electrodes 201 can exist in the form of a metal mesh, and the metal mesh is formed by arranging horizontally and vertically staggered metal lines around each pixel unit.

In an embodiment, the material of the first electrodes 201 is indium tin oxide (ITO).

The manufacturing method includes step S20, forming a first insulating layer on the first electrode layer, wherein a via hole corresponding to the first electrode layer on the first insulating layer is formed through a second mask process.

The material of the first insulating layer 50 can be one or more of silicon nitride, silicon oxide or silicon oxynitride.

Referring to FIG. 5B, after forming the first insulating layer 50, the manufacturing method further includes processing the second mask process, wherein a via hole 501 is formed on the first insulating layer 50 to expose a portion of the first electrode 201 or the second electrode 202. The via hole 501 corresponds to the first electrode 201 or the second electrode 202 in the first electrode layer 20.

The manufacturing method includes step S30, forming a second metal layer on the first insulating layer, wherein a first electrode lead group and a second electrode lead group are formed on the second metal layer through a third mask process, and the first electrode lead group and the second electrode lead group are connected to the first electrode layer through the via hole.

Referring to FIGS. 2 and 5C, in the step, the first electrode lead group 310 includes first electrode leads 311 electrically connected to the first electrodes 201 in the first area 210, and the first electrode lead 311 is led out from a corresponding edge of the first electrode 201 and extends to the bonding area 300 through the touch area 200.

The second electrode lead group 320 includes second electrode leads 321 electrically connected to the second electrodes 202 in the second area 220, and the second electrode lead 321 is led out from a corresponding edge of the second electrode 202 and extends to the bonding area 300 through the touch area 200.

The first electrode leads 311 and the second electrode leads 321 include a first connecting section 401 and a second connecting section 402. One end of the first connecting section 401 is connected to the corresponding first electrode 201 through a via hole 501, and the other end of the first connecting section 401 is connected to the second connecting section 402. One end of the second connecting section 402 is perpendicularly connected to the first connecting section 401, and the other end of the second connecting section 402 extends to the bonding area 300.

In an embodiment, the via hole 501 is formed on a first insulating layer 50 of the first electrode layer 20, and the via hole 501 is located at a position where the first electrodes 201 or the second electrodes 202 are close to a frame of the touch panel 100.

In an embodiment, the first connecting section 401 is parallel to the first direction, and the second connecting section 402 is perpendicular to the first direction. In an embodiment, the first direction is a vertical direction.

In an embodiment, the first connecting section 401 is in a horizontal direction and is located directly above or below the first electrodes 201 or the second electrodes 202. In an embodiment, the second connecting section 402 is in a vertical direction and is perpendicular to the first electrodes 201 or the second electrodes 202.

In an embodiment, the bonding area 300 includes a first bonding region 301 and a second bonding region 302. The first electrode leads 311 extend to the first bonding region 301 through the touch area 200. The second electrode leads 321 extend to the second bonding region 302 through the touch area 200. The second connecting section 402 of the second electrode leads 321 extends to the second binding region 302 through the touch region 200.

In an embodiment, the first bonding region 301 and the second bonding region 302 are symmetrically disposed with the center line of the touch panel 100 as an axis.

In an embodiment, the first binding region 301, the second bonding region 302, and the first electrode layer 20 are located on the same side of the substrate 10.

In an embodiment, the first electrode lead group 310 and the second electrode lead group 320 can be located between the substrate 10 and the first electrode layer 20, or located above the first electrode layer 20 away from the substrate 10. The position can be set in any combination in the above area.

In the embodiment, the first electrode lead group 310 and the second electrode lead group 320 are located above the first electrode layer 20 away from the substrate 10.

Referring to FIG. 5C, after completing the electrode lead group, the manufacturing method further includes forming a second insulating layer 60 on the first electrode layer 20, such that the second insulating layer 60 covers the second electrode layer 70.

The material of the second insulating layer 60 can be one or more of silicon nitride, silicon oxide or silicon oxynitride.

In an embodiment, the metal material of the second metal layer can be the same as the material of the first metal layer.

The manufacturing method further includes step S40, forming a third metal layer on a side of the substrate away from the first electrode layer, wherein the third metal layer forms a second electrode layer and third electrode lead group electrically connected to the second electrode layer through a fourth mask process.

Referring to FIGS. 3 and 5D, step S40 specifically includes: step S401, forming a third metal layer on a side of the substrate away from the first electrode layer; step S402, the third metal layer forms a second electrode layer and third electrode lead group electrically connected to the second electrode layer through the fourth mask process.

The second electrode layer 70 includes third electrodes 701 arranged in a second direction. The third electrodes 701 are arranged in parallel with each other.

In an embodiment, the shape of the third electrode 701 is one of a long strip, a square, or a diamond. When the third electrodes 701 are a plurality of bulk electrodes, the bulk electrodes are electrically connected by metal wires to form the third electrodes 701.

In an embodiment, the third electrodes 701 can exist in the form of a metal mesh, and the metal mesh is formed by arranging horizontally and vertically staggered metal lines around each pixel unit.

The third electrode lead group 330 includes third electrode leads 331 electrically connected to the third electrodes 701, wherein one of the third electrode leads 331 is led out from a corresponding side of the third electrode 701 adjacent to the bonding area 300 and extends to the bonding area 300.

In an embodiment, the second direction is a horizontal direction. Each of the third electrodes 701 is perpendicular to the second direction.

In an embodiment, the third electrodes 701 are disposed perpendicular to the first electrodes 201, and the third electrodes 701 is disposed perpendicular to the second electrodes 202.

The bonding area 300 further includes a third bonding region 303. The third bonding region 303 and the second electrode layer 70 are located on the same side of the substrate 10 and located in the middle of the touch panel 100. The third electrode leads 331 are connected to the third bonding region 303.

A first angle is formed between the third electrode lead 331 and the third bonding region 303. The first angle between the third electrode lead 331 and the third bonding region 303 near a boundary of the touch panel 100 is the smallest. The first angle between the third electrode lead 331 and the third bonding region 303 located at an intermediate portion of the touch panel 100 is the largest. This connection mode reduces the spacing of the third electrode lead group 330 to be disposed at the lower frame, which is advantageous for the narrow bezel design of the display device.

In an embodiment, the metal material of the third metal layer can be the same as the material of the first metal layer and the second metal layer.

Referring to FIG. 5D, after forming the second electrode layer 70, the manufacturing method further includes forming a third insulating layer 80 on the second electrode layer 70, and the material of the third insulating layer 80 can be one or more of silicon nitride, silicon oxide or silicon oxynitride.

The present disclosure provides a touch panel, a manufacturing method thereof, and an electronic device. The touch panel includes a touch area and a bonding area. The touch area is provided with a substrate, a first electrode layer, and at least one electrode lead group. The first electrode layer includes first electrodes and second electrodes. The electrode lead group includes electrode leads, wherein one of the electrode leads corresponds to one of the first electrodes or one of the second electrodes. Each of the electrode leads is led out from an edge of the first electrode or an edge of the second electrode and extends to the bonding area through the touch area. The present disclosure disposes the touch trace located in the touch area. Thus, a width of the black frame of the touch panel is reduced, and a narrow bezel design is realized, which improves the user experience.

The present disclosure has been described with preferred embodiments thereof and it is understood that many changes and modifications to the described embodiments can be carried out without departing from the scope and the spirit of the disclosure that is intended to be limited only by the appended claims.

What is claimed is:

1. A touch panel, comprising:
a touch area and a bonding area located on a side of the touch area, wherein the touch area is provided with:
a substrate;
a first electrode layer located on a side of the substrate and including first electrodes and second electrodes arranged in a first direction; and
at least one electrode lead group including electrode leads, wherein one of the electrode leads corresponds to one of the first electrodes or one of the second electrodes;
each of the electrode leads is led out from an edge of the first electrode or an edge of the second electrode and extends to the bonding area through the touch area.

2. The touch panel according to claim 1, wherein the touch area includes a first area and a second area;
the first area is provided with the first electrodes;
the second area is provided with the second electrodes.

3. The touch panel according to claim 2, wherein the touch panel comprises a first electrode lead group and a second electrode lead group;
the first electrode lead group includes first electrode leads electrically connected to the first electrodes in the first area, and the first electrode lead is led out from a corresponding edge of the first electrode and extends to the bonding area through the touch area;
the second electrode lead group includes second electrode leads electrically connected to the second electrodes in the second area, and the second electrode lead is led out from a corresponding edge of the second electrode and extends to the bonding area through the touch area.

4. The touch panel according to claim 3, wherein the first electrode leads and the second electrode leads include a first connecting section and a second connecting section;
one end of the first connecting section is connected to the corresponding first electrode through a via hole, and the other end of the first connecting section is connected to the second connecting section;
one end of the second connecting section is perpendicularly connected to the first connecting section, and the other end of the second connecting section extends to the bonding area;
the first connecting section is parallel to the first direction, and the second connecting section is perpendicular to the first direction.

5. The touch panel according to claim 3, wherein the bonding area includes a first bonding region and a second bonding region;
the first electrode leads extend to the first bonding region through the touch area;
the second electrode leads extend to the second bonding region through the touch area;
the first bonding region, the second bonding region, and the first electrode layer are located on the same side of the substrate.

6. The touch panel according to claim 1, wherein the electrode lead group is located between the substrate and the first electrode layer, or the electrode lead group is located above the first electrode layer away from the substrate.

7. The touch panel according to claim 6, wherein a first insulating layer is disposed between the electrode lead group and the first electrode layer.

8. The touch panel according to claim 1, wherein the touch area is further provided with:
a second electrode layer located on a side of the substrate away from the first electrode layer and including third electrodes arranged in a second direction; and
a third electrode lead group including third electrode leads electrically connected to the third electrodes, wherein one of the third electrode leads is led out from a corresponding side of the third electrode adjacent to the bonding area and extends to the bonding area.

9. The touch panel according to claim 8, wherein the bonding area further includes a third bonding region;
the third bonding region and the second electrode layer are located on the same side of the substrate;
the third electrode leads are connected to the third bonding region.

10. The touch panel according to claim 9, wherein a first angle is formed between the third electrode lead and the third bonding region;
the first angle between the third electrode lead and the third bonding region near a boundary of the touch panel is the smallest;
the first angle between the third electrode lead and the third bonding region located at an intermediate portion of the touch panel is the largest.

11. The touch panel according to claim 8, wherein the third electrodes are disposed perpendicular to the first electrodes, and the third electrodes are disposed perpendicular to the second electrodes.

12. The touch panel according to claim 8, wherein the third electrode lead group and the second electrode layer are disposed in the same layer.

13. An electronic device, comprising:
a touch panel and a flexible circuit board connected to the touch panel, wherein the touch panel includes a touch area and a bonding area located on a side of the touch area, and the touch area is provided with:
a substrate;
a first electrode layer located on a side of the substrate and including first electrodes and second electrodes arranged in a first direction; and
at least one electrode lead group including electrode leads, wherein one of the electrode leads corresponds to one of the first electrodes or one of the second electrodes;
each of the electrode leads is led out from an edge of the first electrode or an edge of the second electrode and extends to the bonding area through the touch area.

14. The electronic device according to claim 13, wherein the touch area includes a first area and a second area;
the first area is provided with the first electrodes;
the second area is provided with the second electrodes;
the touch panel comprises a first electrode lead group and a second electrode lead group;
the first electrode lead group includes first electrode leads electrically connected to the first electrodes in the first area, and the first electrode lead is led out from a corresponding edge of the first electrode and extends to the bonding area through the touch area;
the second electrode lead group includes second electrode leads electrically connected to the second electrodes in the second area, and the second electrode lead is led out from a corresponding edge of the second electrode and extends to the bonding area through the touch area.

15. The electronic device according to claim 14, wherein the first electrode leads and the second electrode leads include a first connecting section and a second connecting section;
one end of the first connecting section is connected to the corresponding first electrode through a via hole, and the other end of the first connecting section is connected to the second connecting section;
one end of the second connecting section is perpendicularly connected to the first connecting section, and the other end of the second connecting section extends to the bonding area;
the first connecting section is parallel to the first direction, and the second connecting section is perpendicular to the first direction.

16. The electronic device according to claim 14, wherein the bonding area includes a first bonding region and a second bonding region;
the first electrode leads extend to the first bonding region through the touch area;
the second electrode leads extend to the second bonding region through the touch area;
the first bonding region, the second bonding region, and the first electrode layer are located on the same side of the substrate.

17. The electronic device according to claim 13, wherein the touch area is further provided with:
a second electrode layer located on a side of the substrate away from the first electrode layer and including third electrodes arranged in a second direction; and
a third electrode lead group including third electrode leads electrically connected to the third electrodes, wherein one of the third electrode leads is led out from a corresponding side of the third electrode adjacent to the bonding area and extends to the bonding area;
the bonding area further includes a third bonding region;
the third bonding region and the second electrode layer are located on the same side of the substrate;
the third electrode leads are connected to the third bonding region.

18. The electronic device according to claim 13, wherein the flexible circuit board includes:
a first terminal area corresponding to the first bonding region;
a second terminal area corresponding to the second bonding region; and
a third terminal area corresponding to the third bonding region;
the first terminal area and the second terminal area are located on one side of the substrate in the touch panel, and the third terminal area is located on the other side of the substrate in the touch panel.

19. A manufacturing method of a touch panel, comprising steps of:
S10, providing a substrate and forming a first metal layer on the substrate, wherein the first metal layer is formed into a first electrode layer through a first mask process;
S20, forming a first insulating layer on the first electrode layer, wherein a via hole corresponding to the first electrode layer on the first insulating layer is formed through a second mask process;
S30, forming a second metal layer on the first insulating layer, wherein a first electrode lead group and a second electrode lead group are formed on the second metal layer through a third mask process, and the first electrode lead group and the second electrode lead group are connected to the first electrode layer through the via hole;
S40, forming a third metal layer on a side of the substrate away from the first electrode layer, wherein the third metal layer forms a second electrode layer and a third electrode lead group electrically connected to the second electrode layer through a fourth mask process.

20. The manufacturing method according to claim 19, wherein before the step S40, the manufacturing method further comprises forming a second insulating layer on the second metal layer; after the step S40, the manufacturing method further comprises forming a third insulating layer on the third metal layer.
